(19) United States
(12) Patent Application Publication
(10) Pub. No.: US 2023/0397759 A1
(43) Pub. Date: Dec. 14, 2023

(54) CLEANING CUP FOR COFFEE MACHINE AND COFFEE MACHINE

(71) Applicant: JIETAI PURIFICATION TECH CO., LTD, ZHONGSHAN (CN)

(72) Inventor: Xiaoping HUANG, ZHONGSHAN (CN)

(73) Assignee: JIETAI PURIFICATION TECH CO., LTD, ZHONGSHAN (CN)

(21) Appl. No.: 18/456,608

(22) Filed: Aug. 28, 2023

(30) Foreign Application Priority Data
Jul. 26, 2023 (CN) 202321989199.6

(51) Int. Cl. A47J 31/60; A47J 31/44

(52) U.S. Cl. CPC A47J 31/60; A47J 31/4403

(57) ABSTRACT

The present invention provides a cleaning cup for coffee machine and a coffee machine. The cleaning cup comprises a main cup body, a water injection assembly, at least a liquid-discharging hole group, and a liquid-discharging tube. When the cleaning cup is fittingly arranged on the extracting parts of the coffee machine, the water injection assembly injects liquid into the main cup body to mix with a detergent within the cup body. The detergent rapidly dissolves in water to form a washing liquid, and the washing liquid is conveyed to the gaps between the extracting parts of the coffee machine through the liquid-discharging hole group and the liquid-discharging tube, thereby flushing away residual coffee grounds and coffee stains. The present invention has advantages of simple to use, convenient operations, easy promotions and implementations.

### CROSS-REFERENCE TO RELATED APPLICATIONS

The application claims priority to Chinese patent application No. 202321989199.6, filed on Jul. 26, 2023, the entire contents of which are incorporated herein by reference.

### TECHNICAL FIELD

The present invention belongs to the technical field of coffee machines, and particularly relates to a cleaning cup for coffee machine and a coffee machine.

### BACKGROUND

As world globalization develops by leaps and bounds, coffee has gradually become a part of people's lives. A coffee machine is a device that can rapidly extract coffee liquids from coffee powders, which plays a vital role in the process of making coffee. The existing coffee machine has low cleaning efficiency after the coffee has been made. Coffee powder residues are often remained between extracting parts, and gaps between the coffee extracting parts generally needs to be cleaned with the help of small tools, thus the cleaning efficiency is low, which will affect the coffee making speed of the coffee machine. Besides, if the coffee machine has not been cleaned for a long time, bacteria will grow rapidly; and the extracting parts are blocked easily as well, thereby affecting normal operations of the coffee machine. Therefore, improvements are urgently needed for solving the above problems.

### SUMMARY

In order to solve the above technical problems that the coffee powder residues are remained between the extracting parts of the existing coffee machine, the cleaning is difficult and the cleaning efficiency is low, the present invention provide a cleaning cup for coffee machine.

Another purpose of the present invention is to provide a coffee machine with a cleaning cup.

The present invention adopts the following solutions: a cleaning cup for coffee machine, comprising a main cup body for holding a detergent, wherein the main cup body is provided with a water injection assembly, a downwardly extending liquid-discharging tube at its bottom, and liquid-discharging hole groups on its circumference. The water injection assembly is used for injecting liquids into the main cup body to mix with the detergent within the main cup body, so as to form a washing liquid, and then the washing liquid is conveyed to the coffee machine through the liquid-discharging hole groups and liquid-discharging tube.

Preferably, the main cup body is provided with a flow-rate adjusting mechanism, and the flow-rate adjusting mechanism is used for adjusting a liquid-discharging flow of the liquid-discharging hole groups.

Preferably, the flow-rate adjusting mechanism includes a rotating cup body rotatably arranged on the main cup body, and output hole groups arranged on the rotating cup body at the positions corresponding to the liquid-discharging hole groups. The rotating cup body can be rotated relative to the main cup body so that a cup wall of the rotating cup body can gradually close the liquid-discharging hole groups or the output hole groups can gradually communicate with the liquid-discharging hole groups.

Preferably, the rotating cup body is provided with a reserving hole at the position corresponding to the liquid-discharging tube, and the liquid-discharging tube extends from the bottom of the main cup body in a direction toward the reserving hole and penetrates through the reserving hole to protrude out of a bottom of the rotating cup body. The reserving hole is a waist-shaped hole that extends along the circumferential direction of the bottom of the rotating cup.

Preferably, the liquid-discharging hole group includes a first-stage liquid-discharging hole provided on the outer wall of the main cup body, and a second-stage liquid-discharging hole spaced apart from the first-stage liquid-discharging hole along a circumferential direction of the main cup body. Liquids in the main cup body can be discharged from the first-stage liquid-discharging hole or/and the second-stage liquid-discharging hole.

Preferably, multiple second-stage liquid-discharging holes are arranged at intervals along a length direction of the main cup body, and the number of the second-stage liquid-discharging holes is greater than that of the first-stage liquid-discharging holes.

Preferably, the output hole group include a first-stage output hole provided on the outer wall of the rotating cup body, and a second-stage output hole spaced apart from the first-stage output holes along the circumferential direction of the rotating cup body, and the liquids in the main cup body can be discharged from the first-stage output hole or/and the second-stage output hole.

Preferably, an aperture of the first-stage output hole is greater than that of the first-stage liquid-discharging hole, and an aperture of the second-stage output hole is greater than a sum of the aperture of multiple second-stage liquid-discharging holes.

Preferably, multiple groups of the liquid-discharging hole group are circumferentially arranged at intervals along the outer wall of the main cup body, and multiple groups of the output hole group are correspondingly arranged on the outer wall of the rotating cup body.

Preferably, a rotational limiting structure is provided between the main cup body and the rotating cup body, the rotational limiting structure is used to limit a relative rotation of the main cup body and the rotating cup body, thus to adjust a range of rotation angles of the rotating cup body relative to the main cup body.

Preferably, the rotational limiting structure includes a snap-fit bump provided on the main cup body, and a first-stage snap-fit opening, a second-stage snap-fit opening and a third-stage snap-fit opening sequentially arranged at intervals on the rotating cup body along the circumferential direction of the rotating cup body.

When the snap-fit bump is caught within the first-stage snap-fit opening, the cup wall of the rotating cup body seals the liquid-discharging hole group.

When the snap-fit bump is caught within the second-stage snap-fit opening, the first-stage liquid-discharging hole is communicated with the first-stage output hole, and the cup wall of the rotating cup body seals the second-stage liquid-discharging hole.

When the snap-fit bump is caught within the third-stage snap-fit opening, the first-stage output hole is communicated with the first-stage liquid-discharging hole, and the second-stage output hole is communicated with the second-stage liquid-discharging hole.

Preferably, the main cup body includes a main body and a cup lid arranged on the main body, and the water injection assembly is arranged on the cup lid. When the cup lid is covered on the main body, the water injection assembly can be communicated with the inside of the main cup body so as to inject water into the main cup body.

Preferably, the cup lid can be turned in a direction close to or away from the main cup body, thus to cover on the main cup body or to connect the main cup body with the external environment.

Preferably, the cup lid is integrally formed with the main body.

Preferably, the water injection assembly includes:
a first-stage bulge, which is provided on the cup lid and is provided with a first-stage water injection hole thereon;
a second-stage bulge, which is provided on an outside of the first-stage bulge and is provided with a second-stage water injection hole thereon; and
a check valve, which is sleeved on the second-stage bulge, wherein when water is injected into the second-stage water injection hole to push the check valve downwardly to form elastic deformations, the check valve opens the second-stage water injection hole, so that the second-stage water injection hole can be communicated with the inside of the main cup body.

Preferably, a sealing mechanism is arranged between the cup lid and the main body, and the sealing mechanism is used to seal a gap between the cup lid and the main body.

Preferably, the sealing mechanism includes a sealing groove arranged between the outer wall of the main cup body and the cup lid, and a sealing ring fittingly arranged within the sealing groove. The sealing groove is arranged circumferentially along the outer wall of the main cup body.

Preferably, a fixing mechanism is arranged between the main cup body and the cup lid, when the cup lid is covered on the main cup body, the fixing mechanism is used to fix the cup lid to the main cup body.

Preferably, the fixing mechanism includes a snap-fit hole arranged between the cup lid and the main cup body, and a snap-fit member located between the cup lid and the main cup body and fittingly arranged within the snap-fit hole. The snap-fit member is provided with a hook portion, when the cup lid is covered on the main cup body, the hook portion rests against the snap-fit hole, so that the cup lid is fixed to the main cup body.

Preferably, an anti-dropping mechanism is arranged between the main cup body and the rotating cup body, when the rotating cup body is sleeved on the main cup body, the anti-dropping mechanism is used to limit the rotating cup body to move downwardly relative to the main cup body.

Preferably, the anti-dropping mechanism includes a limiting member provided on the bottom of the main cup body, a through-hole provided on the rotating cup body at a position corresponding to the limiting member, and a limiting slot arranged on a periphery of the through-hole. When the rotating cup body is sleeved on the main cup body, the limit member fittingly extends into the through-hole and rests against the limiting slot, so as to limit the rotating cup body to move downwardly relative to the main cup body.

Preferably, the limiting member includes a communicating portion provided on the bottom of the main cup body, and a limiting rim provided on an outer periphery of the communicating portion. The communicating portion extends along a length direction of the main cup body. When the rotating cup body is sleeved on the main cup body, the communicating portion fittingly extends into the through-hole, and the limiting rim rests against a bottom of the limiting slot, so as to limit the rotating cup body to move downwardly relative to the main cup body.

A coffee machine comprises the cleaning cup for coffee machine as described above.

Compared with the existing technology, the present invention has the following beneficial effects:

The present invention provides a cleaning cup for coffee machine, wherein the cleaning cup for coffee machine comprises a main cup body, a water injection assembly, at least a liquid-discharging hole group, and a liquid-discharging tube. When the cleaning cup for coffee machine is fittingly arranged on the extracting parts of the coffee machine, the water injection assembly injects liquid into the main cup body to mix with the detergent within the cup body. The detergent rapidly dissolves in water to form a washing liquid, then the washing liquid is conveyed to the gaps between the extracting parts of the coffee machine through the liquid-discharging hole group and the liquid-discharging tube, thus to flush away the residual coffee grounds and coffee stains. The present invention has the advantages of simple to use, convenient operations, and easy promotions and implementations.

The present invention provides a coffee machine comprising a cleaning cup, so that the coffee machine can be cleaned easily, which has the advantages of simple to use, convenient operations and promotions.

### BRIEF DESCRIPTION OF DRAWINGS

In order to more clearly illustrate the technical solutions in the embodiments of the present invention, the drawings needed in the descriptions of the embodiments will be briefly introduced hereafter.

FIG. 1 is a schematic structure view of a cleaning cup for coffee machine according to the present invention.

FIG. 2 is a schematic structure view of the cleaning cup for coffee machine according to the present invention from another point of view.

FIG. 3 is an exploded structure view of the cleaning cup for coffee machine according to the present invention.

FIG. 4 is an exploded structure view of the cleaning cup for coffee machine according to the present invention from another point of view.

FIG. 5 is a schematic view that a cup lid of the cleaning cup for coffee machine is covered on an inner cup body and a snap-fit bump is matched in a first-stage snap-fit opening according to the present invention.

FIG. 6 is a schematic view that the cup lid of the cleaning cup for coffee machine is covered on the inner cup body and the snap-fit bump is matched in a second-stage snap-fit opening according to the present invention.

FIG. 7 is a schematic view that the cup lid of the cleaning cup for coffee machine is covered on the inner cup body and the snap-fit bump is matched in a third-stage snap-fit opening according to the present invention.

FIG. 8 is a top plan view of the cleaning cup for coffee machine according to the present invention.

FIG. 9 is a sectional view of line B-B in FIG. 8 according to the present invention.

FIG. 10 is a sectional view of line A-A in FIG. 8 according to the present invention.

FIG. 11 is a schematic assembling view of the cleaning cup for coffee machine and a component of the coffee machine according to the present invention.

### DETAILED DESCRIPTION OF THE EMBODIMENTS

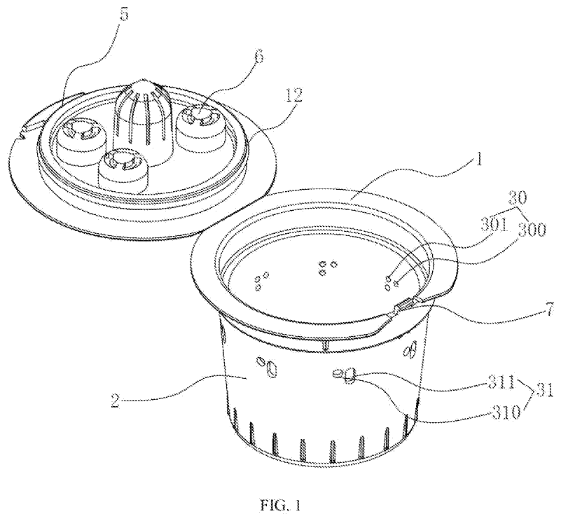

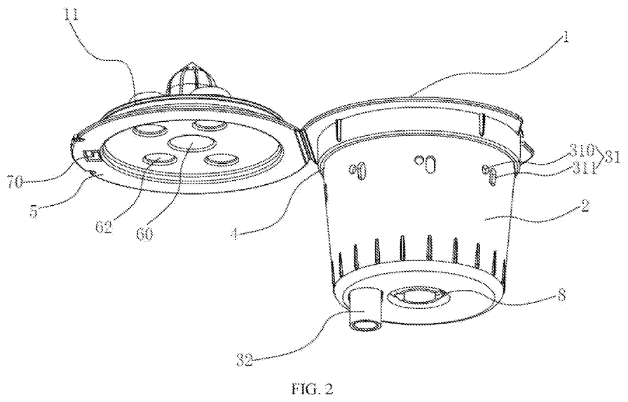

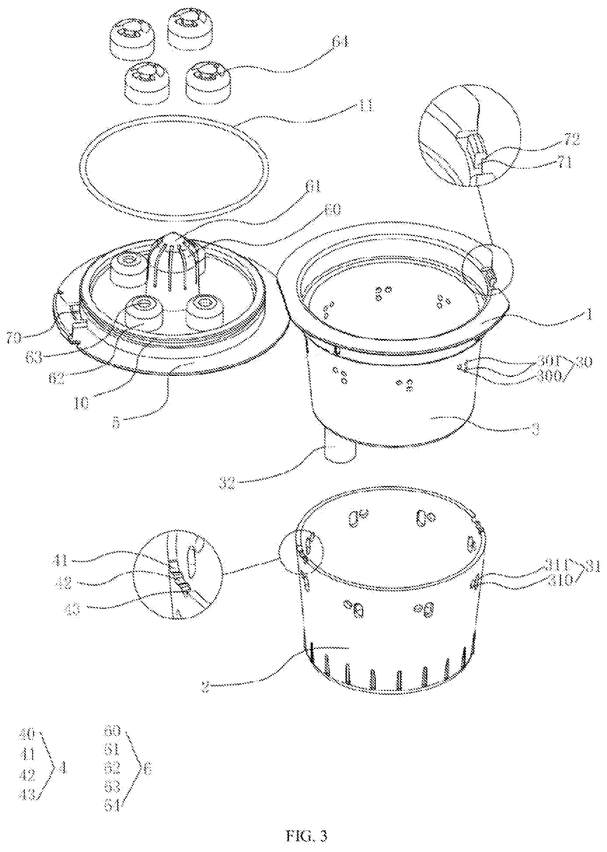

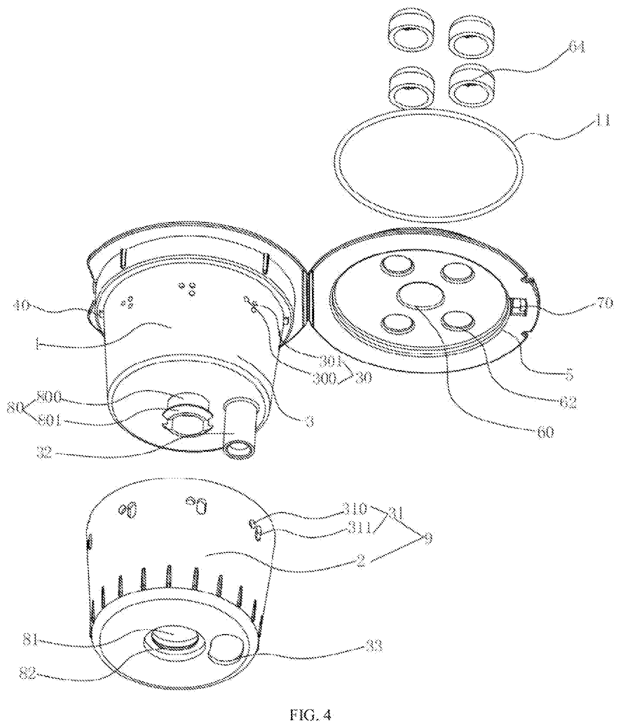

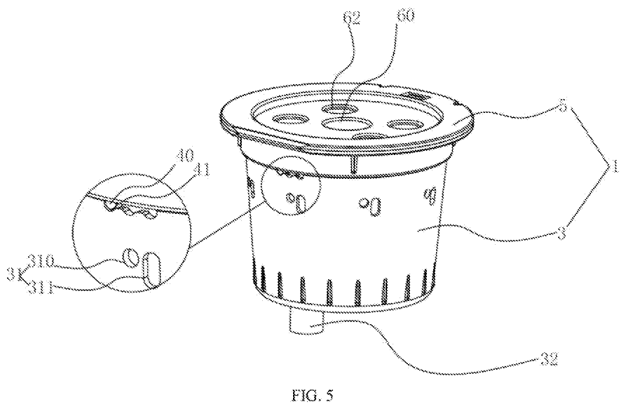

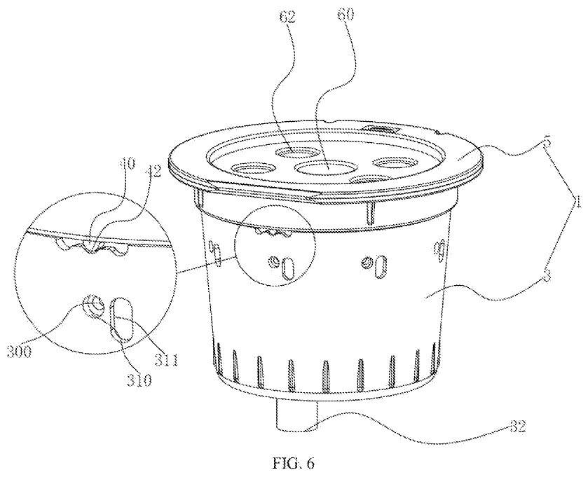

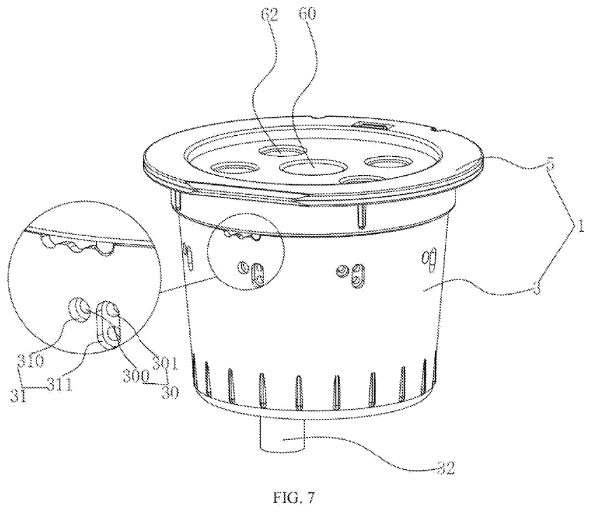

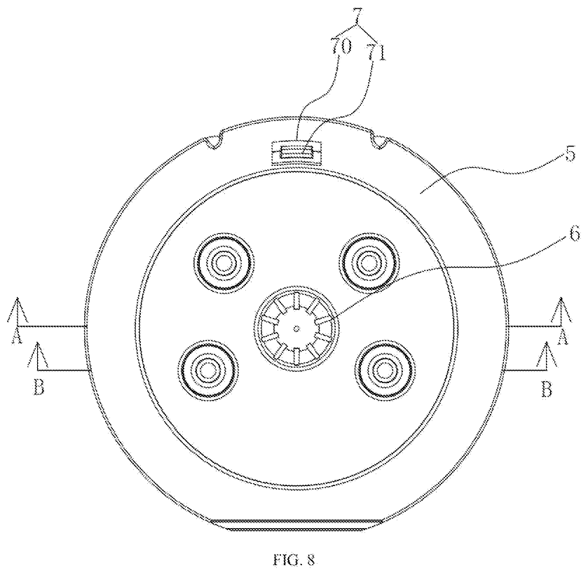

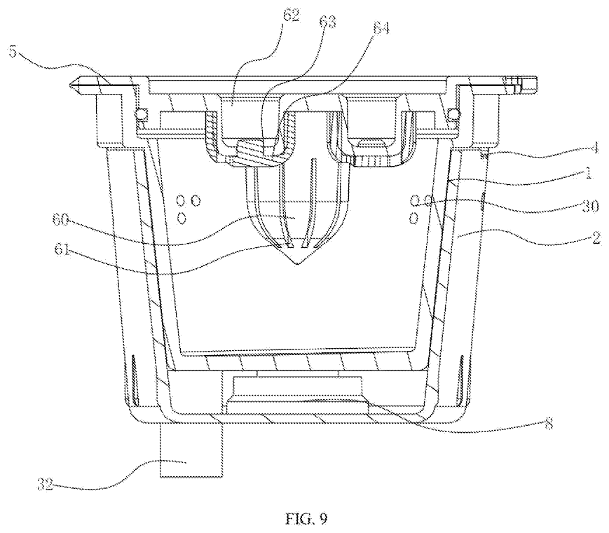

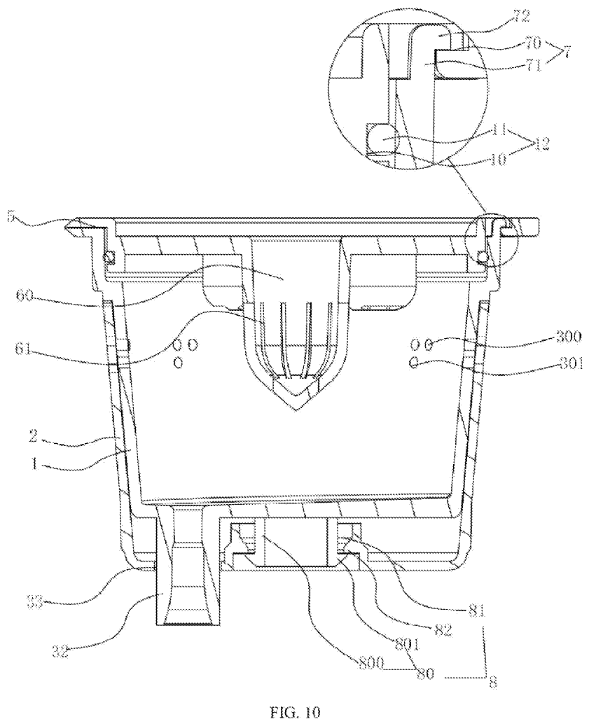

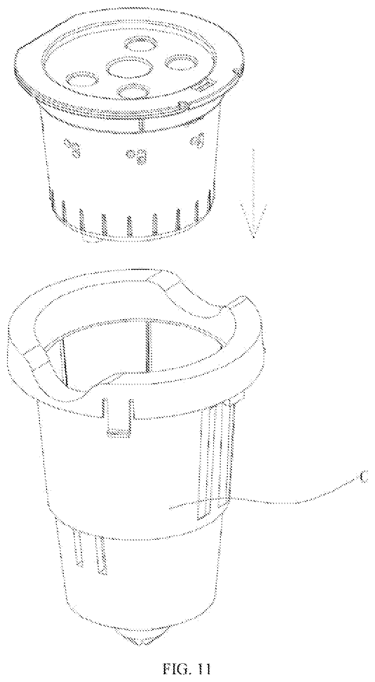

As shown in FIG. 1 to FIG. 11, a cleaning cup for coffee machine is matched and sleeved in a component C of a coffee machine. The cleaning cup for coffee machine comprises a main cup body 1 for holding a detergent, wherein the main cup body 1 is provided with a water injection assembly 6, a downwardly extending liquid-discharging tube 32 at its bottom, and at least a liquid-discharging hole group 30 on its circumference. The water injection assembly 6 is used for injecting liquid into the main cup body 1 to mix with the detergent within the main cup body 1, and then the mixed liquid is conveyed to the component C of the coffee machine through the liquid-discharging hole group 30 and the liquid-discharging tube 32, and further is transmitted to the coffee machine, thus to flush away the residual coffee grounds and coffee stains.

The present invention provides a cleaning cup for coffee machine, wherein the cleaning cup for coffee machine comprises a main cup body, a water injection assembly, at least a liquid-discharging hole group, and a liquid-discharging tube. When the cleaning cup of coffee machine is fittingly arranged on extracting parts of coffee machine, the water injection assembly injects liquids into the main cup body to mix with a detergent within the main cup body. The detergent rapidly dissolves in the injected water to form a washing liquid, and then the washing liquid is conveyed to gaps between the extracting parts of the coffee machine through the liquid-discharging hole group and the liquid-discharging tube, thus to flush away the residual coffee grounds and coffee stains. The present invention has the advantages of simple to use, easy operations, and convenient promotions and implementations.

Preferably, the main cup body 1 is provided with a flow-rate adjusting mechanism 9, which is used to adjust a liquid-discharging flow of the liquid-discharging hole group 30.

Preferably, the flow-rate adjusting mechanism 9 comprises a rotating cup body 2 rotatably sleeved on the main cup body 1, and at least an output hole group 31 provided on the rotating cup body 2 at the positions corresponding to the liquid-discharging hole group 30. The rotating cup body 2 can be rotated relative to the main cup body 1 so that a cup wall of the rotating cup body 2 can gradually seal the liquid-discharging hole group 30 or the output hole group 31 can gradually communicate with the liquid-discharging hole group 30.

Preferably, the rotating cup body 2 is provided with a reserving hole 33 at a position corresponding to the liquid-discharging tube 32, and the liquid-discharging tube 32 extends from the bottom of the main cup body 1 in a direction toward the reserving hole 33 and penetrates through the reserving hole 33 to protrude out of a bottom of the rotating cup body 2. The reserving hole 33 is a waist-shaped hole that extends along the circumferential direction on the bottom of the rotating cup 2.

Preferably, the liquid-discharging hole group 30 comprises a first-stage liquid-discharging hole 300 provided on an outer wall of the main cup body 1, and at least a second-stage liquid-discharging hole 301 spaced apart from the first-stage liquid-discharging hole 300 along a circumferential direction of the main cup body 1. Liquids within the main cup body 1 can be discharged from the first-stage liquid-discharging hole 300 or/and the second-stage liquid-discharging hole 301.

Preferably, multiple second-stage liquid-discharging holes 301 are arranged at intervals along a height direction of the main cup body 1, and the number of the second-stage liquid-discharging holes 301 is greater than that of the first-stage liquid-discharging hole 300.

Preferably, the output hole group 31 comprise a first-stage output hole 310 provided on an outer wall of the rotating cup body 2, and a second-stage output hole 311 spaced apart from the first-stage output hole 310 along a circumferential direction of the rotating cup body 2. The liquids in the main cup body 1 can be discharged from the first-stage output hole 310 or/and the second-stage output hole 311 after passing through the liquid-discharging hole group 30.

Preferably, an aperture of the first-stage output hole 310 is greater than that of the first-stage liquid-discharging hole 300, and an aperture of the second-stage output hole 311 is greater than a sum of the apertures of multiple second-stage liquid-discharging holes 301.

Preferably, multiple liquid-discharging hole groups 30 are circumferentially arranged at intervals along the outer wall of the main cup body 1, and multiple output hole groups 31 are correspondingly arranged on the outer wall of the rotating cup body 2.

Preferably, at least a rotational limiting structure 4 is provided between the main cup body 1 and the rotating cup body 2, the rotational limiting structure 4 is used to limit a relative rotation of the main cup body 1 and the rotating cup body 2, and to adjust a range of rotation angles of the rotating cup body 2 relative to the main cup body 1.

Preferably, the rotational limiting structure 4 comprises a snap-fit bump 40 provided on the main cup body 1, and a first-stage snap-fit opening 41, a second-stage snap-fit opening 42 and a third-stage snap-fit opening 43 that are sequentially arranged at intervals on the rotating cup body 2 along the circumferential direction of the rotating cup body 2.

When the snap-fit bump 40 is caught within the first-stage snap-fit opening 41, the cup wall of the rotating cup body 2 seals the liquid-discharging hole group 30.

When the snap-fit bump 40 is caught within the second-stage snap-fit opening 42, the second liquid-discharging hole 301 is communicated with the first-stage output hole 310, and the cup wall of the rotating cup body 2 seals the first liquid-discharging hole 300.

When the snap-fit bump 40 is caught within the third-stage snap-fit opening 43, the first-stage output hole 310 is communicated with the first-stage liquid-discharging hole 300, and the second-stage output hole 311 is communicated with the second-stage liquid-discharging hole 301.

In practical implementations, the flow of the washing liquid flowing from the liquid-discharging hole groups through the output hole groups into the coffee machine can be adjusted through the rotational limiting structure, so that multi-stages cleaning of the inside of the coffee machine can be realized. When there are more coffee grounds, a high flow of the washing liquid can be used; otherwise, a low flow of the washing liquid can be used. The flow adjustment of the washing liquid is realized by the relative rotation between the main cup body and the rotating cup body, which is very convenient to use. When the cleaning cup for coffee machine is fittingly arranged in the extracting parts of the coffee machine, the water injection assembly injects liquids into the main cup body to mix with a detergent within the cup body, and the mixed washing liquid is conveyed to the gaps between the extracting parts of the coffee machine through the liquid-discharging hole groups and the liquid-discharging tube, thus to flush away the residual coffee grounds. The present invention has the advantages of simple to use, convenient operations, and easy promotions and implementations.

Preferably, the main cup body 1 includes a main body 3 and a cup lid 5 provided on the main body 3. The water injection assembly 6 is provided on the cup lid 5, when the cup lid 5 is covered on the main body 3, the water injection assembly 6 can communicate with the inside of the main cup body 1, thus to inject water into the main cup body 1.

Preferably, the cup lid 5 can be turned in a direction close to or away from the main body 3, thus to cover on the main body 3 or to connect the main body 3 with the external environment.

Preferably, the cup lid 5 is integrally formed with the main body 3.

Preferably, the water injection assembly 6 includes:
a first-stage bulge 60, which is provided on the cup lid 5 and is provided with a first-stage water injection hole 61 thereon;
at least a second-stage bulge 62, which is provided on an outside of the first-stage bulge 60 and is provided with a second-stage water injection hole 63 thereon;
at least a check valve 64, which is sleeved on the second-stage bulge 62, wherein when the check valve 64 is pushed downwardly by water injected into the second-stage water injection hole 63 to form elastic deformations, the check valve 64 turns on the second-stage water injection hole 63, so that the second-stage water injection hole 63 can be communicated with an inside of the main cup body 1.

In practical implementations, different types of the coffee machines have different quantities of water injection holes, by providing the first-stage water injection hole and multiple second-stage water injection holes on the cup lid, the high-efficiency cleaning cup can be adapted to various types of coffee machines, which has the advantages of wide utilizations and strong adaptabilities. When the coffee machine is only fitted with the first-stage bulge 60 and is communicated with the first-stage water injection hole 61 for injecting water, the check valve 64 can be used to prevent the washing liquid within the main cup body 1 from flowing backwardly through the second-stage water injection holes 63.

Preferably, a sealing mechanism 12 is provided between the cup lid 5 and the main body 3, the sealing mechanism 12 is used to seal the gaps between the cup lid 5 and the main body 3.

Preferably, the sealing mechanism 12 comprises a sealing groove 10 arranged between an inner wall of the main body 3 and the cup lid 5, and a sealing ring 11 fittingly arranged within the sealing groove 10. The sealing groove 10 is circumferentially arranged along the inner wall of the main body 3.

Preferably, a fixing mechanism 7 is arranged between the main body 3 and the cup lid 5. When the cup lid 5 is covered on the main body 3, the fixing mechanism 7 is used to fix the cup lid 5 to the main body 3.

Preferably, the fixing mechanism 7 comprises a snap-fit hole 70 arranged between the cup lid 5 and the main body 3, and a snap-fit member 71 located between the cup lid 5 and the main body 3 and matched with the snap-fit hole 70. The snap-fit member 71 is provided with a hook portion 72, when the cup lid 5 is covered on the main body 3, the hook portion 72 is rests against the snap-fit hole 70 so as to fix the cup lid 5 to the main body 3.

Preferably, an anti-dropping mechanism 8 is provided between the main cup body 1 and the rotating cup body 2, when the rotating cup body 2 is sleeved on the main cup body 1, the anti-dropping mechanism 8 is used to limit the rotating cup body 2 to move downwardly relative to the main cup body 1.

Preferably, the anti-dropping mechanism 8 comprises a limiting member 80 located on the bottom of the main cup body 1, a through-hole 81 provided on the rotating cup body 2 at a position corresponding to the limiting member 80, and a limiting slot 82 provided at an inner circumference of the through-hole 81. When the rotating cup body 2 is sleeved on the main cup body 1, the limiting member 80 fittingly extends into the through-hole 81 and rests against the limiting slot 82, so as to limit the rotating cup body 2 to move downwardly relative to the main cup body 1.

Preferably, the limiting member 80 includes a communicating portion 800 provided at the bottom of the main cup body 1, and a limiting rim 801 provided on a periphery of the communicating portion 800. The communicating portion 800 extends along a height direction of the main cup body 1. When the rotating cup body 2 is sleeved on the main cup body 1, the communicating portion 800 fittingly extends into the through-hole 81, the limiting rim 801 rests against a bottom of the limiting groove 82 so as to limit the rotating cup body 2 to move downwardly relative to the main cup body 1.

The present invention further provides a coffee machine, comprising the cleaning cup for coffee machine as described above. The cleaning cup for coffee machine comprises a main cup body, a water injection assembly, at least a liquid-discharging hole group, and a liquid-discharging tube. When the cleaning cup for coffee machine is fittingly arranged in the extracting parts of the coffee machine, the water injection assembly injects liquids into the main cup body to mix with a detergent within the cup body. The detergent rapidly dissolves in water to form a washing liquid, and the washing liquid is conveyed to the gaps between the extracting parts of the coffee machine through the liquid-discharging hole groups and the liquid-discharging tube, thus to flush away the residual coffee grounds and the coffee stains. The present invention has the advantages of simple to use, convenient operations, and easy promotions and implementations.

The above described are only some preferred embodiments of the present invention, and they are not used to limit the present invention. Any modifications, equivalent replacements and improvements made within the spirits and principles of the present invention should be all included in the protection scope of the present invention.

What is claimed is:

1. A cleaning cup for coffee machine, comprising a main cup body, wherein the main cup body is provided with a water injection assembly, a downwardly extending liquid-discharging tube at its bottom, and at least a liquid-discharging hole group on its peripheral side.

2. The cleaning cup for coffee machine according to claim 1, wherein the main cup body is provided with a flow-rate adjusting mechanism for adjusting a liquid-discharging flow of the liquid-discharging hole group.

3. The cleaning cup for coffee machine according to claim 2, wherein the flow-rate adjusting mechanism includes a rotating cup body rotatably arranged on the main cup body, and at least an output hole group arranged on the rotating cup body; the rotating cup body is rotatable relative to the main cup body so that a cup wall of the rotating cup body gradually closes the liquid-discharging hole group or the output hole group gradually communicates with the liquid-discharging hole group; and a reserving hole is provided at a bottom of the rotating cup body for allowing the liquid-discharging tube to extend downwardly.

4. The cleaning cup for coffee machine according to claim 3, wherein the liquid-discharging hole group comprises a first-stage liquid-discharging hole provided on an outer wall of the main cup body, and a second-stage liquid-discharging hole spaced apart from the first-stage liquid-discharging hole along a circumferential direction of the main cup body, and liquid in the main cup body is discharged from the first-stage liquid-discharging hole or/and the second-stage liquid-discharging hole; and
the output hole group comprises a first-stage output hole provided on an outer wall of the rotating cup body, and a second-stage output hole spaced apart from the first-stage output holes along a circumferential direction of the rotating cup body, and liquid in the main cup body is discharged from the first-stage output hole or/and the second-stage output hole.

5. The cleaning cup for coffee machine according to claim 4, wherein a rotational limiting structure is provided between the main cup body and the rotating cup body, and the rotational limiting structure is used to limit a relative rotation between the main cup body and the rotating cup body, and to adjust a range of rotation angle of the rotating cup body relative to the main cup body.

6. The cleaning cup for coffee machine according to claim 5, wherein the rotational limiting structure comprises a snap-fit bump provided on the main cup body, and a first-stage snap-fit opening, a second-stage snap-fit opening and a third-stage snap-fit opening sequentially arranged at intervals on the rotating cup body along the circumferential direction of the rotating cup body:
when the snap-fit bump is caught within the first-stage snap-fit opening, the cup wall of the rotating cup body seals the liquid-discharging hole group;
when the snap-fit bump is caught within the second-stage snap-fit opening, the second liquid-discharging hole is communicated with the first-stage output hole, and the cup wall of the rotating cup body seals the first liquid-discharging hole; and
when the snap-fit bump is caught within the third-stage snap-fit opening, the first-stage output hole is communicated with the first-stage liquid-discharging hole, and the second-stage output hole is communicated with the second-stage liquid-discharging hole.

7. The cleaning cup for coffee machine according to claim 1, wherein the main cup body includes a main body and a cup lid arranged on the main body, and the water injection assembly is arranged on the cup lid; when the cup lid is covered on the main body, the water injection assembly is communicated with an inside of the main cup body so as to inject water into the main cup body.

8. The cleaning cup for coffee machine according to claim 7, wherein the water injection assembly includes:
a first-stage bulge, which is provided on the cup lid and is provided with a first-stage water injection hole thereon;
at least a second-stage bulge, which is provided on an outside of the first-stage bulge and is provided with a second-stage water injection hole thereon; and
at least a check valve, which is sleeved on the second-stage bulge, wherein when the check valve is pushed downwardly by water injected into the second-stage water injection hole to form elastic deformations, the check valve turns on the second-stage water injection hole, so that the second-stage water injection hole is communicated with the inside of the main cup body.

9. The cleaning cup for coffee machine according to claim 7, wherein a sealing mechanism is arranged between the cup lid and the main body, the sealing mechanism includes a sealing groove arranged between an inner wall of the main body and the cup lid, and a sealing ring fittingly arranged within the sealing groove.

10. The cleaning cup for coffee machine according to claim 7, wherein a fixing mechanism is arranged between the main body and the cup lid, when the cup lid is covered on the main body, the fixing mechanism is used to fix the cup lid to the main body.

11. The cleaning cup for coffee machine according to claim 10, wherein the fixing mechanism comprises a snap-fit hole arranged between the cup lid and the main body, and a snap-fit member located between the cup lid and the main body and matched with the snap-fit hole; the snap-fit member is provided with a book portion, when the cup lid is covered on the main body, the hook portion rests against the snap-fit hole, so that the cup lid is fixed to the main body.

12. The cleaning cup for coffee machine according to claim 3, wherein an anti-dropping mechanism is arranged between the main cup body and the rotating cup body, when the rotating cup body is sleeved on the main cup body, the anti-dropping mechanism is used to limit the rotating cup body to move downwardly relative to the main cup body.

13. The cleaning cup for coffee machine according to claim 12, wherein the anti-dropping mechanism comprises a limiting member provided on the bottom of the main cup body, a through-hole provided on the rotating cup body and located at a position corresponding to the limiting member, and a limiting slot arranged on an inner circumference of the through-hole; when the rotating cup body is sleeved on the main cup body, the limit member fittingly extends into the through-hole and rests against the limiting slot, so as to limit the rotating cup body to move downwardly relative to the main cup body.

14. The cleaning cup for coffee machine according to claim 13, wherein the limiting member includes a communicating portion provided on the bottom of the main cup body, and a limiting rim provided on an outer periphery of the communicating portion, the communicating portion extends along a height direction of the main cup body; when the rotating cup body is sleeved on the main cup body, the communicating portion fittingly extends into the through-hole, and the limiting rim rests against a bottom of the limiting slot, so as to limit the rotating cup body to move downwardly relative to the main cup body.

15. A coffee machine, comprising the cleaning cup for coffee machine according to claim 1.
